(19) United States
(12) Patent Application Publication
(10) Pub. No.: US 2004/0096258 A1
(43) Pub. Date: May 20, 2004

(54) Vibration lipstick

(76) Inventor: Ji Soo Kim, Seoul (KR)

Correspondence Address: W Norman Roth, Roth & Goldman, Suite 707, 523 West Sixth Street, Los Angeles, CA, 90014, US

(21) Appl. No.: 10/433,267

(22) PCT Filed: Nov. 30, 2001
(86) PCT No.: PCT/KR01/02076

(30) Foreign Application Priority Data
Dec. 1, 2000 (KR) 2000-33731

(51) Int. Cl. B43K 29/00; B43M 1/02

(52) U.S. Cl. 401/1; 401/195

(57) ABSTRACT

A vibrating lipstick is disclosed, in which devices for generating heat and vibrations are installed within the cover of the lipstick so as to generate heat and vibrations. Thus the cosmetic makeup can be carried out more efficiently, the skin health is promoted, and the formation of the wrinkles on the skin can be prevented. The vibrating lipstick includes the following elements. That is, it includes upper and lower covers, and a power switch is formed on the cover, for turning on or off a power supply. A heating wire is installed along an inside wall of the cover, for receiving a power from a battery, the battery being installed within the cover. That is, heating and vibrating functions are added to the general lipstick, so that a heating massage can be done before or after a cosmetic makeup regardless of the place.

### FIELD OF THE INVENTION

The present invention relates to a lipstick. Particularly the present invention relates to a vibrating lipstick in which devices for generating heat and vibrations are installed within the cover of the lipstick so as to generate heat and vibrations. Thus the cosmetic makeup can be carried out more efficiently, the skin health is promoted, and the formation of the wrinkles on the skin can be prevented.

### BACKGROUND OF THE INVENTION

Generally, when females do cosmetic makeup, they use different cosmetic products of different ingredients depending on the types of skins. Even if the different cosmetic products are used, the cosmetics are well received into the skin in some cases, and the cosmetics are not well received into the skin in some other cases depending on the types of the skin. However, when the cosmetic makeup is carried out, if the skin is warmed, then the blood circulation is promoted, and the cosmetics are well received into the skin owing to the catalytic effect of the circulating blood.

Meanwhile, the massager is widely used as an auxiliary therapeutic device for various illnesses.

The examples of this massager include: one for massaging or finger-pressing the waist portion, one for massaging or finger-pressing the foot and leg, and other portions of the human body. Thus these massaging products are commercialized in various forms.

However, this massager is limited in its use to a particular portion of the human body. That is, it can massage or finger-press only a particular portion of the human body. Further, it cannot be carried with, and therefore, portable massagers have been developed.

This portable massager overcomes the place limit, and therefore, it is so much convenient.

However, this portable massager is small in its bulk, and therefore, it is liable to be lost. Further, this portable massager cannot serve as a cosmetic aid, but only is an auxiliary therapeutic device for carrying out the physical treatment.

### SUMMARY OF THE INVENTION

The present invention is intended to overcome the above described disadvantages of the conventional devices.

Therefore it is an object of the present invention to provide a vibrating lipstick in which the lipstick as a necessarily carrying article is provided with heating and vibrating functions so as to prevent the formation of the skin wrinkles and so as to promote the skin health, as well as excluding the possibility of being lost.

Generally, the articles which are necessarily carried by women include the compact cosmetic powder and the lipstick. Further, generally females do the cosmetic makeup during the outdoor activities intermittently or after having food.

Therefore, in the present invention, the cover of the lipstick is made to generate heat, and a massage can be done during the cosmetic makeup, thereby letting the cosmetic ingredients intrude well into the skin. Thus the effects of the cosmetic makeup are enhanced.

Further, the lipstick which is used many times a day is provided with a vibrating function, so that a massaging effect can be realized during the cosmetic makeup.

In achieving the above object, the vibrating lipstick according to the present invention includes: upper and lower covers; a power switch formed on the cover, for turning on or off a power supply; and a heating wire installed along an inside wall of the cover, for receiving a power from a battery, the battery being installed within the cover.

The vibrating lipstick according to the present invention further includes: a motor installed within the cover, for generating a dynamic power; and a vibrator installed on a shaft of the motor, for generating vibrations.

### BRIEF DESCRIPTION OF THE DRAWINGS

The above object and other advantages of the present invention will become more apparent by describing in detail the preferred embodiment of the present invention with reference to the attached drawings in which:

FIG. 1 is an exploded perspective view of the general lipstick;

FIG. 2 is a schematic perspective view of the vibrating lipstick according to the present invention; and

FIG. 3 is a sectional view of the vibrating lipstick according to the present invention.

### DETAILED DESCRIPTION OF THE PREFERRED EMBODIMENT

The present invention will be described in detail referring to the attached drawings.

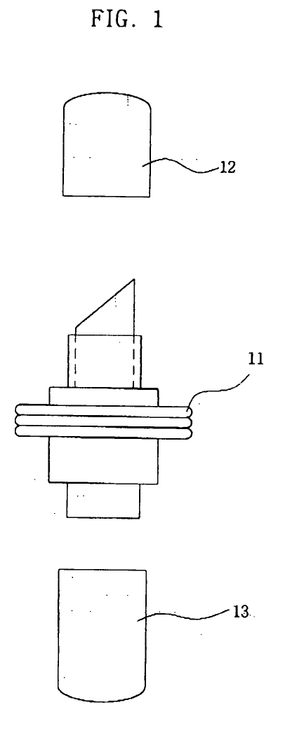

FIG. 1 is an exploded perspective view of the general lipstick. As shown in this drawing, the lipstick includes: a lipstick main body 11, an upper cover 12, and a lower cover 13.

In this general lipstick, the lipstick main body 11 is secured into the lower cover 13, and when the lipstick is to be used, the upper cover 12 is taken off.

In the present invention, there are installed a battery, a motor and a heating wire within the upper cover 12 or the lower cover 13, and thus vibrating and heating functions are provided. In the present invention, it will be assumed that the mentioned functions are provided in the lower cover 13.

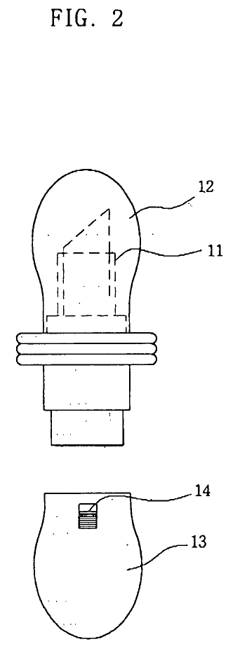

FIG. 2 is a schematic perspective view of the vibrating lipstick according to the present invention. As shown in this drawing, the lower cover 13 has a round shape so that massages would be possible. Further, a sliding type power switch 14 is formed on the surface of the lower cover 13, so that the power source can be turned on and off.

Alternatively, in order to improve the aesthetics, the sliding type switch is not used, but the switching function is realized by turning the lower cover 13, in a state with the main body 11 and the upper cover 12 and the lower cover 13 assembled together.

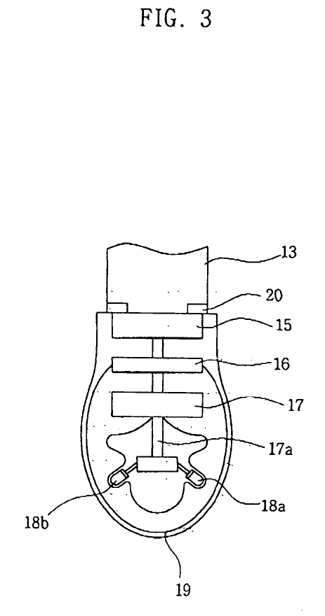

FIG. 3 is a sectional view of the vibrating lipstick according to the present invention. Within the lower cover 13, there is installed a battery 15 such as a watch battery, the line of which is turned on or off by the power switch 14. On the battery 15, there is installed a power distributor 16 for distributing the power of the battery 15.

Further, a dc motor 17 is connected to the power distributor 16 which activates the motor 17. Further, a pair of vibrators 18a and 18b are installed on the leading end of a motor shaft 17a of the dc motor 17, so that the vibrators 18a and 18b can generate vibrations upon activating the dc motor 17.

Further, a heating wire 19 (such as nichrome wire or a heating fiber) is installed along the inner wall of the lower cover 13, so that the heating wire 19 can generate heat by receiving power from the battery 15. Accordingly, the lower cover 13 is made of a metal so that the lower cover 13 can easily conduct the heat from the heating wire 19.

Further, a securing member 20 is installed to firmly secure the battery 15 in a stable form. The securing member 20 is installed such that the battery 15 can be easily replaced, and the main body 11 and the lower cover 13 are mutually separable from each other, and thus, the battery 15 can be replaced.

When the massaging lipstick of the present invention is to be used, first the power switch 14 is turned on. Thus the power line is connected, and the power of the battery 15 is distributed by the power distributor 16, so that the power can be transmitted to both the dc motor 17 and the heating wire 19.

Accordingly, the dc motor 17 generates motions, and the vibrators 18a and 18b perform free oscillations, thereby imposing the vibrations onto the inner side of the lower cover 13. Meanwhile, the lower cover 13 is also heated by the heating wire 19 which has been heated by receiving the power from the power distributor 16. Therefore, the lipstick of the present invention has heating and vibrating functions.

Meanwhile, instead of the vibrators which are connected to the motor shaft, there can be generated ultrasonic waves to give a massaging effect to the skin of the human body.

Further, the lipstick of the present invention is not only applicable to the lipstick, but also can be applied to other lipstick-shaped cosmetic articles.

In the above, the present invention was described based on the specific preferred embodiments and the attached drawings, but it should be apparent to those ordinarily skilled in the art that various changes and modifications can be added without departing from the spirit and scope of the present invention, which will be defined in the appended claims.

According to the present invention as described above, heating and vibrating functions are added to the general lipstick, so that a heating massage can be done before or after a cosmetic makeup regardless of the place. Accordingly, the cosmetic ingredients can easily intrude into the skin. Further, massages can be done around the eyes, around the mouth, and on the neck, so that the formation of the wrinkles on the skin can be prevented, as well as promoting the skin health.

Further, any fatigue can be dissipated by massaging the eyes and around the eyes.

What is claimed is:

1. A vibrating lipstick comprising:
upper and lower covers;
a power switch formed on the cover, for turning on or off a power supply; and
a heating wire installed along an inside wall of the cover, for receiving a power from a battery, the battery being installed within the cover.

2. The vibrating lipstick as claimed in claim 1, further comprising:
a motor installed within the cover, for generating a dynamic power; and
a vibrator installed on a shaft of the motor, for generating vibrations.
